(19) United States
(12) Patent Application Publication
(10) Pub. No.: US 2024/0423248 A1
(43) Pub. Date: Dec. 26, 2024

(54) IN-SITU PASTEURIZATION OF AN ELECTRONIC LIQUID COOLING LOOP

(71) Applicant: International Business Machines Corporation, Armonk, NY (US)

(72) Inventors: Allan Cory VanDeventer, Poughkeepsie, NY (US); MILNES P. DAVID, New Paltz, NY (US); Brandon M. Kobilka, Fishkill, NY (US); Yuanchen Hu, Peekskill, NY (US)

(21) Appl. No.: 18/211,742

(22) Filed: Jun. 20, 2023

(51) Int. Cl. A23L 3/00; A23L 3/02; A23L 3/36

(52) U.S. Cl. CPC A23L 3/003; A23L 3/02; A23L 3/36

(57) ABSTRACT

Provided is a system, method, and computer program product for in-situ pasteurization of electronics cooling liquid of an electronic liquid cooling loop. A processor may activate a cooling liquid pasteurization system that allows for pasteurization of the electronics cooling liquid. The processor may detect a temperature of the electronics cooling liquid, where heat generated by computer electronics of a computer system is transferred to the electronics cooling liquid. The processor may determine that the temperature of the electronics cooling liquid is within a target range that neutralizes bacteria. The processor may maintain the temperature of the electronics cooling liquid for a target time using the heat generated by the computer electronics of the computer system, where the target time corresponds to a pasteurization time frame for neutralizing bacteria in the electronics cooling liquid. The processor may deactivate the cooling liquid pasteurization system when the target time has been reached.

### BACKGROUND

The present disclosure relates generally to the field of electronic equipment cooling mechanisms, and more particularly to in-situ pasteurization of an electronic liquid cooling loop.

As computer technology evolves, there has been an increase in signal processing and transferring demands. Because of the increased demands, IT equipment (e.g., servers, mainframes, etc.) has resulted in constant power increases to match the demand. As a result of the high power demands, temperature increases have also occurred that require improved cooling techniques/mechanisms, one of which is utilizing liquid cooling loops. Because liquid cooling has higher cooling potential, more IT equipment are adopting liquid cooling loops inside to achieve enhanced cooling performance.

### SUMMARY

Embodiments of the present disclosure include a system, method, and computer program product for in-situ pasteurization of electronics cooling liquid of an electronic liquid cooling loop. A processor may activate a cooling liquid pasteurization system that allows for pasteurization of the electronics cooling liquid. The processor may detect a temperature of the electronics cooling liquid, where heat generated by computer electronics of the computer system is transferred to the electronics cooling liquid. The processor may determine that the temperature of the electronics cooling liquid is within a target range that neutralizes bacteria. The processor may maintain the temperature of the electronics cooling liquid for a target time using the heat generated by the computer electronics of the computer system, where the target time corresponds to a pasteurization time frame for neutralizing bacteria in the electronics cooling liquid. The processor may deactivate the cooling liquid pasteurization system when the target time has been reached.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates an IT equipment system, in accordance with embodiments of the present disclosure.

FIG. 2 illustrates a process for in-situ pasteurization of an IT equipment system, in accordance with embodiments of the present disclosure.

FIG. 3 illustrates an example process diagram for in-situ pasteurization of an IT equipment system, in accordance with embodiments of the present disclosure.

FIG. 4 illustrates an IT equipment system including a by-path pasteurization loop and detector, in accordance with an embodiment of the present disclosure.

FIG. 5 illustrates an example process for in-situ pasteurization of the IT equipment system of FIG. 4, in accordance with an embodiment of the present disclosure.

FIG. 6 illustrates a high-level block diagram of an example computer system that may be used in implementing one or more of the methods, tools, and modules, and any related functions, described herein, in accordance with embodiments of the present disclosure.

FIG. 7 depicts a schematic diagram of a computing environment for executing program code related to the methods disclosed herein and for in-situ pasteurization of electronics cooling liquid, according to at least one embodiment.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of electronic equipment cooling mechanisms, and more particularly to in-situ pasteurization of an electronic liquid cooling loop. While the present disclosure is not necessarily limited to such applications, various aspects of the disclosure may be appreciated through a discussion of various examples using this context.

As computer technology evolves, there has been an increase in signal processing and transferring demands. Because of the increased demands, IT equipment (e.g., servers, mainframes, etc.) has resulted in constant power increases to match the demand. As a result of the high power demands, temperature increases have also occurred that require improved cooling techniques, one of which is utilizing liquid cooling loops. Because liquid cooling has higher cooling potential, more IT equipment are adopting liquid cooling loops inside to achieve enhanced cooling performance. As the liquid cooling loop coolant is rarely replaced, it is an ideal place for bacteria to grow. For example, bacteria may generate biofilm which can clog the liquid cooling loop (cold plate and heat exchanger etc.) and lead to cooling failure.

A biofilm is composed of living bacteria and exists as a colony. The ability to form biofilms is a universal attribute of bacteria. A biofilm forms when bacteria adhere to the surface of objects in a moist environment and begin to reproduce. A biofilm typical forms on surfaces, such as metal, plastic, rubber, solid material, etc., and typically cannot be observed with the naked eye. However, a simple way to neutralize the bacteria is by performing pasteurization. For example, heating the bacteria to various high temperatures may denature and/or neutralize most active bacteria.

Embodiments of the present disclosure are directed to a system, method, and computer program product for in-situ pasteurization of electronics cooling liquid to overcome the bacterial challenges that occur in an electronic liquid cooling loop. The proposed system does not require anti-bacterial solvent, which further prevents potential pollution of the liquid cooling loop. Rather, the proposed system utilizes heat generated from electronic equipment of the system itself to increase the temperature of the cooling liquid of the electronic cooling loop to a pasteurization temperature that neutralizes bacteria. In this way, the system does not require any additional off-site testing or extra services. Rather, the system itself automates bacterial prevention while maintaining coolant temperature levels that have been shown to be fully functional at predetermined pasteurization temperatures and pasteurization times (e.g., 72° C. for 15 seconds).

Based on published pasteurization testing data, results indicate that pasteurization at 72° C. for 15 seconds neutralizes most forms of bacteria (e.g., most yeasts, mold, and common spoilage and pathogenic bacteria).

It is to be understood that the aforementioned advantages are example advantages and should not be construed as limiting. Embodiments of the present disclosure can contain all, some, or none of the aforementioned advantages while remaining within the spirit and scope of the present disclosure.

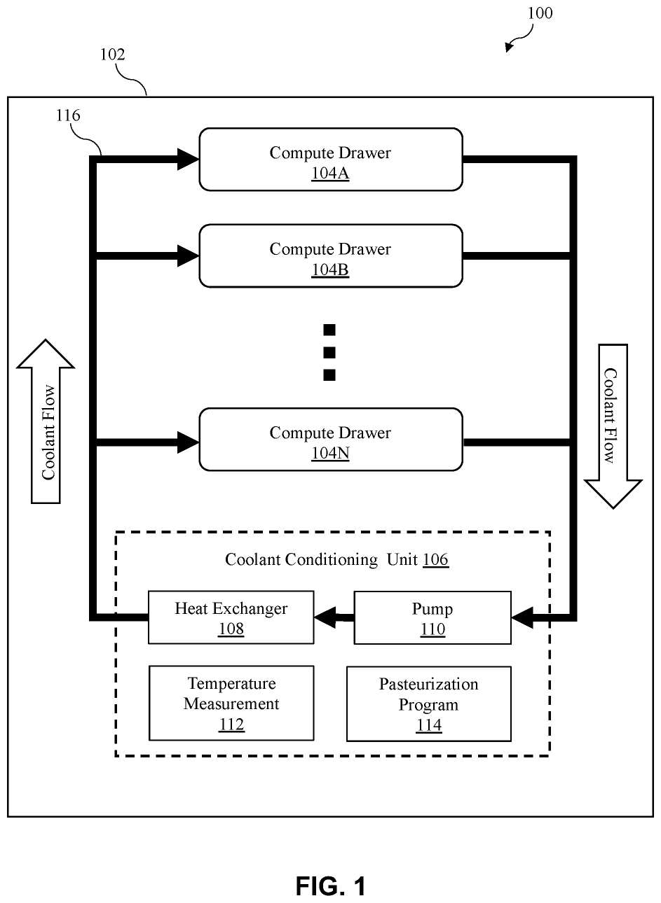

With reference now to FIG. 1, shown is an IT equipment system 100, in accordance with embodiments of the present disclosure. In the illustrated embodiment, the IT equipment system 100 includes an electronic equipment rack 102 that houses compute drawer 104A, compute drawer 104B, and compute drawer 104N (collectively referred to as compute drawer(s) 104. Each compute drawer may include one or more electronic equipment devices or computing systems (e.g., such as servers) that require cooling. The compute drawers 104 are connected to coolant conditioning unit 106 via cooling loop 116. It is contemplated that other electronic connections between coolant conditioning unit 106 and compute drawers 104 and/or computing systems of the drawers may be present, however, for brevity purposes these connections are not shown.

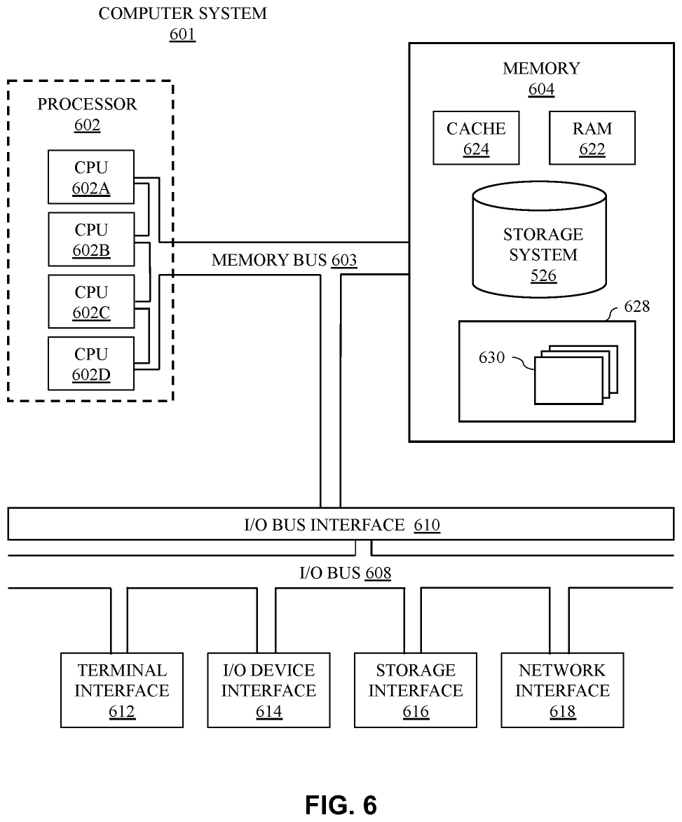

In embodiments, coolant conditioning unit 106 may be configured as any type of computer system and may be substantially similar to computer system 601 of FIG. 6. For example, various processors, memory, interfaces, etc. are not shown in FIG. 1, however, as described in FIG. 6, these components may be included in addition to various components shown in coolant conditioning unit 106.

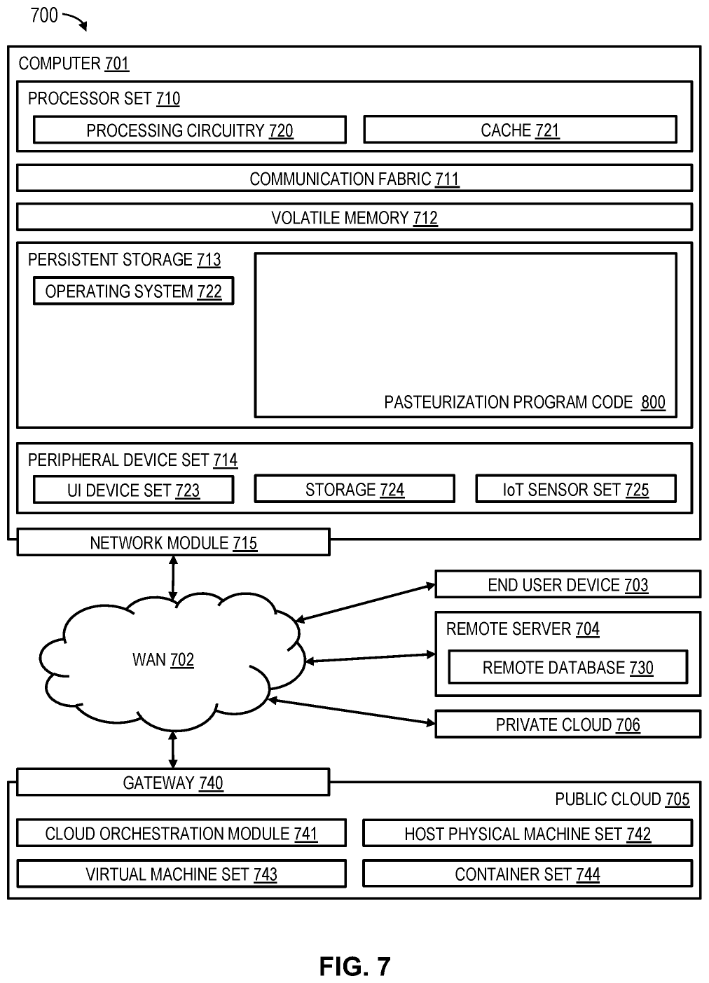

In some embodiments, coolant conditioning unit 106 may be configured as computer 701 of computing environment 700 of FIG. 7. For example, coolant conditioning unit 106 may be communicatively connected to a cloud computing environment, such that various functions and methods may be executed remotely (e.g., by remote users or automated systems) and/or any related data may be collected/stored/analyzed by various networked systems (e.g., artificial intelligence systems, machine learning models, etc.). Consistent with various embodiments, a cloud computing environment may include a network-based, distributed data processing system that provides one or more edge/network/cloud computing services. Further, a cloud computing environment may include many computers (e.g., hundreds or thousands of computers or more) disposed within one or more data centers and configured to share resources over a network.

In the illustrated embodiment, coolant conditioning unit 106 includes heat exchanger 108, pump 110, temperature measurement 112, and pasteurization program 114. In embodiments, cooling loop 116 is configured to cool the electronic equipment of compute drawers 104 by cycling electronics cooling liquid throughout the electronic equipment rack 102. In embodiments, pasteurization program 114 is configured to pasteurize the electronics cooling liquid of the system 100 by maintaining a target pasteurization temperature of the electronics cooling liquid for a target pasteurization time by using heat generated by the electronic devices/computing systems of compute drawers 104.

Pasteurization program 114 may utilize temperature data from temperature measurement component 112 to adjust the temperature of the electronics cooling liquid to pasteurize the cooling loop 116. For example, as electronics cooling liquid is flowing through the cooling loop 116, temperature measurement component 112 will monitor and/or collect temperature data of the electronics cooling liquid as it flows through the IT equipment system 100. Pasteurization program 114 will compare the current temperature of the electronics cooling liquid to a predetermined temperature target (e.g., 72° C.+/−1° C. based on testing) or range that neutralizes bacteria. If within the range, the pasteurizing program will adjust heat exchanger component 108 to maintain the temperature. The heat exchanger component 108 can be either air-to-liquid or liquid-to-liquid heat exchanger. In embodiments, heat exchanger component 108 may be configured as an air to liquid heat exchanger with air moving devices (e.g., a plurality of communicatively connected cooling fans). In some embodiments, the pasteurization program 114 may adjust flow rate of a liquid-to-liquid (e.g., water to water) heat exchanger in order to maintain, reduce, and/or increase temperatures of the electronics cooling liquid.

For example, pasteurization program 114 may adjust the speed of one or more cooling fans such that they reduce the influx of cool air in and warm air out of the system to allow the electronics cooling liquid to increase or maintain a hotter temperature, or increase the speed of the one or more cooling fans such that they increase the influx of cool air in and warm air out of the system to reduce the temperature once pasteurization is complete. For example, testing has indicated that reducing and/or eliminating fan speed of cooling fans (e.g., zero or under 50% speed) may result in an increase in temperature of the electronics cooling liquid from 30° C. to 70° C. within a 40-minute time period. In this way, by only utilizing heat generated from various computing devices/compute drawers 104, pasteurization temperatures (e.g., 72° C.) can be achieved by eliminating or reducing heat exchanging function. Once a target pasteurization time at the target pasteurization temperature has been reached, pasteurization program 114 can reactivate or increase cooling fans to achieve optimal cooling temperatures within the IT equipment system 100.

In embodiments, the pasteurization program 114 may use machine learning models and/or algorithms to improve its capabilities automatically through experience and/or repetition without procedural programming. For example, pasteurization program 114 may use machine learning to make determinations and/or predictions on what the proper pasteurization temperature and pasteurization time period should be based on analysis of historical data/training data. For example, the pasteurization program 114 may utilize machine learning algorithms to analyze historical bacteria detection data gathered over various time points (e.g., hourly, daily, weekly, monthly, etc.) to make predictions on how often and when to run pasteurization processes. Pasteurization program 114 may also analyze historical temperature/time data with respect to bacteria detection data and make determinations and/or predictions on what the most efficient pasteurization time and temperature is with respect to neutralizing the bacteria within the cooling loop. In embodiments, the pasteurization program 114 may adjust/modify/retrain machine learning algorithms as new data is gathered by the system over time that indicates bacterial growth rates have changed. Using the modified/retrain models/algorithms, the system may automatically adjust the predetermined pasteurization time and temperature to make the system run more efficiently without user input.

Machine learning algorithms can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBDT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

It is noted that FIG. 1 is intended to depict the representative major components of an exemplary IT equipment system 100. In some embodiments, however, individual components may have greater or lesser complexity than as represented in FIG. 1, components other than or in addition to those shown in FIG. 1 may be present, and the number, type, and configuration of such components may vary.

For example, while FIG. 1 illustrates an IT equipment system 100 with a single coolant conditioning unit 106, three compute drawers 104, a single cooling loop 116, and a single electronic equipment rack 102, suitable computing environments for implementing embodiments of this disclosure may include any number of cooling conditioning units (e.g., having multiple pumps, heat exchangers, temperature measurement components, programs), compute drawers, cooling loops, and electronic equipment racks. The various modules, systems, and components illustrated in FIG. 1 may exist, if at all, across a plurality of cooling conditioning units, compute drawers, cooling loops, and racks.

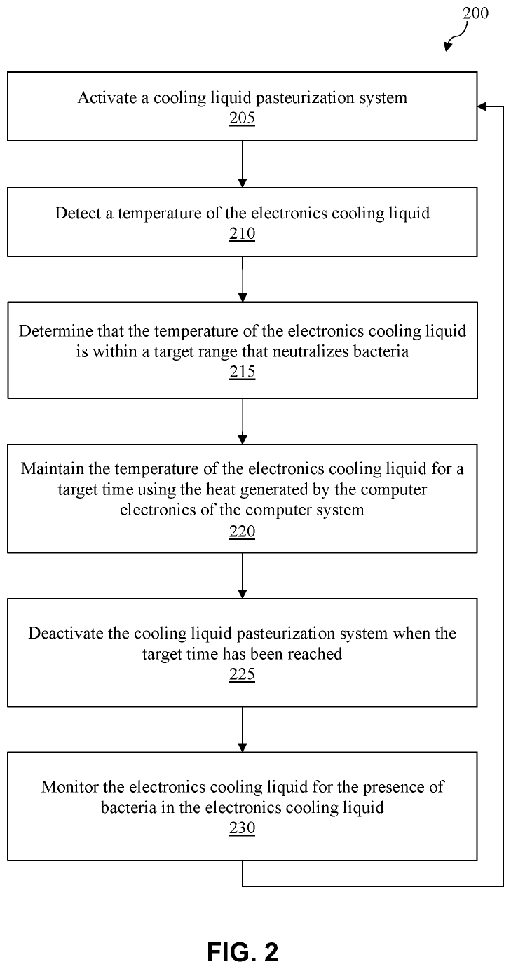

Referring now to FIG. 2, shown is an example process 200 for in-situ pasteurization of an IT equipment system, in accordance with embodiments of the present disclosure. The process 200 may be performed by processing logic that comprises hardware (e.g., circuitry, dedicated logic, programmable logic, microcode, etc.), software (e.g., instructions run on a processor), firmware, or a combination thereof. In some embodiments, the process 200 is a computer-implemented process. In embodiments, the process 200 may be performed by cooling conditioning unit 106 exemplified in FIG. 1.

In embodiments, the process 200 begins by activating a cooling liquid pasteurization system configured to pasteurize the electronics cooling liquid of an IT equipment system. This is shown at step 205. For example, coolant conditioning unit 106 may reduce or eliminate heat exchanging mechanism (e.g., reducing coolant flow rate of air-to-liquid or liquid-to-liquid heat exchanger) in order to increase temperature of the electronics cooling liquid flowing through the electronic cooling loop 116.

The process 200 continues by detecting a temperature of the electronics cooling liquid, wherein heat generated by computer electronics of the computer system is transferred to the electronics cooling liquid. This is shown at step 210. For example, coolant conditioning unit 106 will utilize temperature measurement component 112 to monitor the temperature of the electronics cooling liquid.

The process 200 continues by determining that the temperature of the electronics cooling liquid is within a target pasteurization range that neutralizes bacteria. This is shown at step 215.

The process 200 continues by maintaining the temperature of the electronics cooling liquid for a target pasteurization time using the heat generated by the computer electronics of the computer system, wherein the target time corresponds to a pasteurization time frame for neutralizing bacteria in the electronics cooling liquid. This is shown at step 220. For example, once the temperature is within the target pasteurization range (e.g., 72° C.), coolant conditioning unit 106 will constantly adjust heat exchanger component 108 in order to maintain this temperature for the duration of the target time.

The process 200 continues by deactivating the cooling liquid pasteurization system when the target time has been reached. This is shown at step 225. For example, once the target pasteurization time has been reached, any bacteria within the system shall be neutralized. In response, the pasteurization mechanisms may be deactivated, and cooling processes can return to normal.

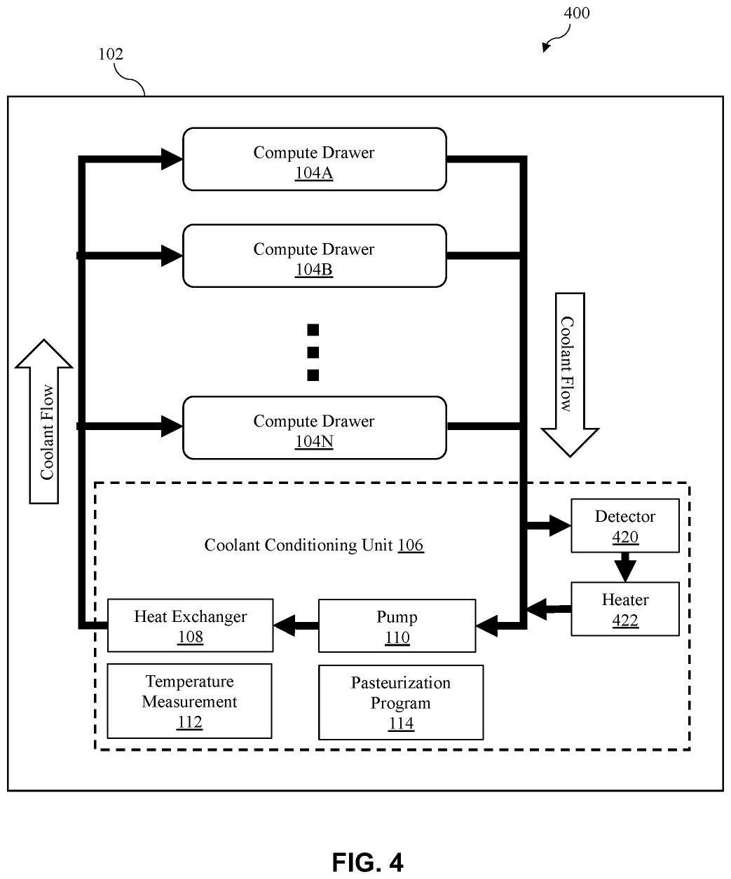

In some embodiments, the process 200 continues by monitoring the electronics cooling liquid for the presence of bacteria in the electronics cooling liquid. This is shown at step 230. For example, in some embodiments (such as IT equipment system 400 described in FIG. 4), equipment may be available to monitor for the presence of bacteria in the loop rather than just operating the in-situ pasteurization system on a predetermined schedule. For example, monitoring the electronics cooling liquid for the presence of bacteria may include sending the electronics cooling liquid through a light scattering detector, analyzing data generated by the light scattering detector to determine a presence of bacteria in the electronics cooling liquid, and identifying, based on the analyzing, the presence of bacteria in the electronics cooling liquid. In this way, if the system identifies any bacteria present in the electronics cooling liquid, the system may automatically activate the pasteurization processes or the pasteurization system by returning to step 205.

In some embodiments, the target pasteurization time may be determined by a machine learning model. For example, the coolant conditioning unit/pasteurization program may utilize a machine learning model that analyzes historical pasteurization data, wherein the historical pasteurization data comprises a plurality of pasteurization time data and a plurality of bacteria sample data. The machine learning model may correlate the plurality of pasteurization time data and the plurality of bacteria sample data to determine an optimal pasteurization time frame for neutralizing bacteria in a given electronics cooling liquid. The machine learning model may identify the target time based on the optimal pasteurization time frame.

In some embodiments, the target pasteurization temperature may be determined by the machine learning model. For example, the coolant conditioning unit/pasteurization program may utilize a machine learning model analyzes the historical pasteurization data, wherein the historical pasteurization data comprises a plurality of pasteurization temperature data and a plurality of bacteria sample data. The machine learning model may correlate the plurality of pasteurization temperature data and the plurality of bacteria sample data to determine an optimal temperature range for neutralizing bacteria in a given electronics cooling liquid. Based on the correlating, the machine learning model may identify target range based on the optimal pasteurization temperature range.

In some embodiments, the machine learning model may be retrained based on new pasteurization data (bacteria detection data, temperature data, time data, etc.). For example, the machine learning model may receive/collect a set of new pasteurization data (real-time/current data). The new data may indicate changes in bacteria neutralization, temperature parameters, and/or pasteurization time requirements. Using the new pasteurization data, the machine learning model may be retrained. Based on the retraining, the machine learning model may adjust algorithms for determining the target pasteurization time and/or target pasteurization temperature.

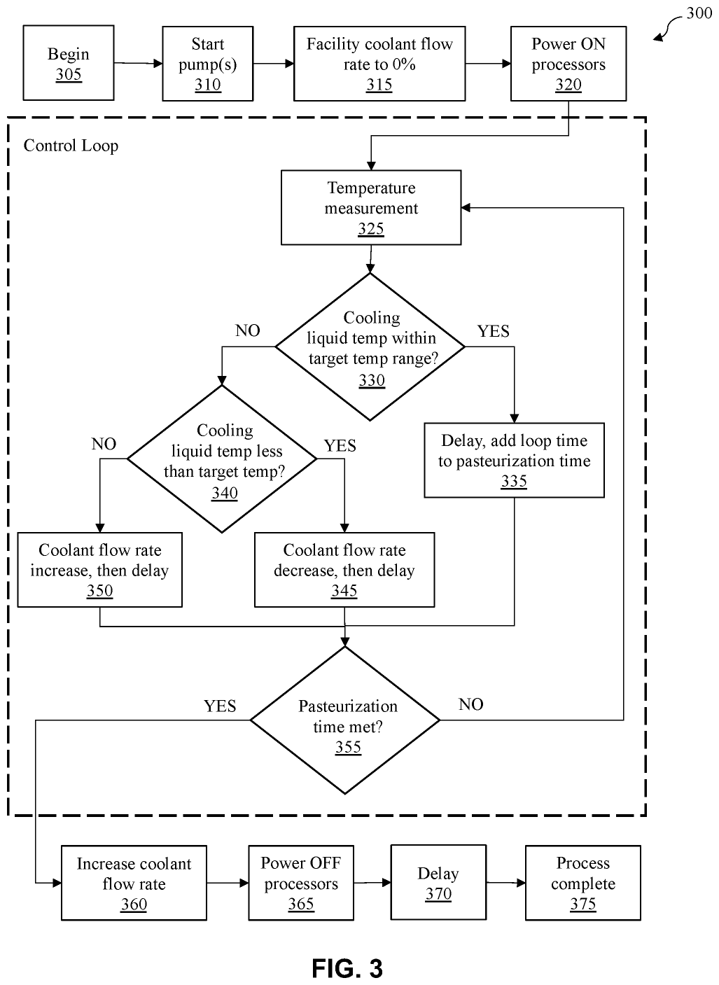

Referring now to FIG. 3, shown is an example process diagram 300 for in-situ pasteurization of an IT equipment system, in accordance with an embodiment of the present disclosure. In some embodiments, the process 300 is a computer-implemented process. In embodiments, the process 300 may be performed by coolant conditioning unit 106 exemplified in FIG. 1.

In embodiments, pasteurization process 300 begins by activating the electronics cooling liquid pasteurization system of IT equipment system. This is shown at step 305. Once activated, the process 300 continues by initiating pumping of electronics cooling liquid through the system. This is shown at step 310. Pasteurization program 114 of coolant conditioning unit 106 is configured to reduce coolant flow rate of one or more heat exchangers to 0%. This is shown at step 315. For example, the coolant conditioning unit 106 may reduce the coolant flow rate on an air-to-liquid heat exchanger (e.g., one or more cooling fans) or a liquid-to-liquid heat exchanger to 0%. The process 300 continues by powering on processors. This is shown at step 320. When coolant flow rate of the heat exchanger is reduced, power and/or heat from active processors allows the temperature of the electronics cooling liquid of the system to increase. For example, an initial temperature of the electronics cooling liquid may be at 25-30° C. Once processors are active and heat exchange mechanisms are reduced (e.g., fan speed adjusted to zero), electronics cooling temperatures may rise to roughly 70° C.-75° C. over a period of time (e.g., 30-60 minutes).

The process 300 continues by monitoring the temperature of the electronics cooling liquid of the cooling loop over the period of time. This is illustrated at step 325. If the electronics cooling liquid is within the target temperature range for neutralizing bacteria (e.g., 72° C.+/−0.2° C.), “YES” at 330, the process 300 continues by delaying heat exchanging and adding loop time to pasteurization time. This is shown at step 335.

If the electronics cooling liquid is not within the target temperature range for neutralizing bacteria (e.g., 72° C.+/−0.2° C.), “NO” at 330, the process 300 continues to step 340. If the electronics cooling liquid temperature is less than the target temperature range, “YES” at 340, the process 300 continues to step 345, where the coolant flow rate of the heat exchanger (e.g., fan speed) is decreased and then delayed once the temperature is within the temperature range.

If the electronics cooling liquid is above the target temperature range for neutralizing bacteria (e.g., 72° C.+/−0.2° C.), “NO” at 340, the process 300 continues to step 350, where the coolant flow rate of the heat exchanger is increased and then delayed once the temperature is within the temperature range. In this way, the system automatically adjusts the coolant flow rate of the heat exchanger (e.g., either increases/decrease fan speed) to bring the electronics cooling liquid within the target temperature range.

The process 300 continues by determining if the pasteurization time has been met. This is shown at step 355. If the pasteurization time required to neutralize the bacteria has been met, then the coolant flow rate of the heat exchanger may be increased, such that the temperature of the electronics cooling liquid may be reduced to cool the system. This is shown at step 360. In embodiments, the processors may be powered off (at step 365) and power may be delayed (at step 370) such that the system is cooled in an efficient manner. Once cooled, the process 300 is completed, as shown at step 375.

If the pasteurization time has not been met, “NO” at step 355, then the process 300 may return to step 325, where the temperature of the electronics cooling liquid is measured to determine whether it is still within the target temperature range. In this way, the system continuously monitors the temperature range of the electronics cooling liquid until pasteurization has been completed.

Referring now to FIG. 4, shown is an IT equipment system 400 including a bypass pasteurization loop and detector, in accordance with an embodiment of the present disclosure. In the illustrated embodiments, the IT equipment system 400 is substantially similar to the IT equipment system 100 of FIG. 1 but includes a bypass pasteurization loop. The bypass loop includes detector 420 and heater 422.

Detector 420 is configured to detect the presence of bacteria within the electronics cooling liquid that passes through the bypass loop. Detector 420 may be any type of detector that can detect the presence of bacteria. For example, detector 420 may be configured as a light scattering detector, however, this example is not meant to be limiting. Pasteurization program 114 may utilize detector 420 to determine if there are bacteria within the cooling liquid loop. If detected, the pasteurization program 114 may automatically perform in-situ pasteurization processes (e.g., processes 200, 300, and 500).

Heater 422 is configured to heat the electronics cooling liquid to the target pasteurization temperature. Heater 422 may be controlled by pasteurization program 114. Pasteurization program 114 may use heater 422 to aid in increasing the temperature of the electronics cooling liquid in addition/supplemental to adjusting heat exchanger component 108 (e.g., reducing fan speed). In some embodiments, pasteurization program 114 may only use heater 422 to increase the temperature of the electronics cooling liquid. In this way, heating steps may be automatically performed without requiring adjusting the fan speed.

In embodiments, heater 422 may heat the electronics cooling liquid (coolant) to a predetermined temperature within the bypass loop according to a bypath heater calculation. For example, assuming the following conditions: an inlet coolant temperature at 40° C., power applied uniformly on the cooling loop's surface, a cooling loop that is fully insulated, an outlet coolant temperature that reaches 75° C., heating length along the pipe is 1 m, 0.1% of coolant in the heating section of the bypass loop, and a 6-gallon cooling loop.

$$Re = \frac{uD}{v} = \frac{0.0 \; 0019279 m / s \times 0.05 m}{3.5 \times 1 {0}^{- 7} {m}^{2} / s} = 27.3$$

$$P = c \dot{m} ( {T}_{m , i} - {T}_{m , o} ) = 54 W$$

$$Note : {{q}^{′}}^{′} = \frac{P}{π DL} = 343.9 W / {m}^{2}$$

At the outlet, fully developed laminar flow,

$$N {u}_{D} = \frac{h D}{K} = 4.36 , so h = \frac{4.36 K}{D} = 58. 5$$

$$W / {m}^{2} K$$

$$So {T}_{s , o} = {T}_{m , o} + \frac{{{q}^{′}}^{′}}{h} = {81}^{°} C .$$

With the above calculation, coolant can be heated to 72° C., and most (e.g., 95%) of the 6 gallons of coolant will be processed/pasteurized in 3 days.

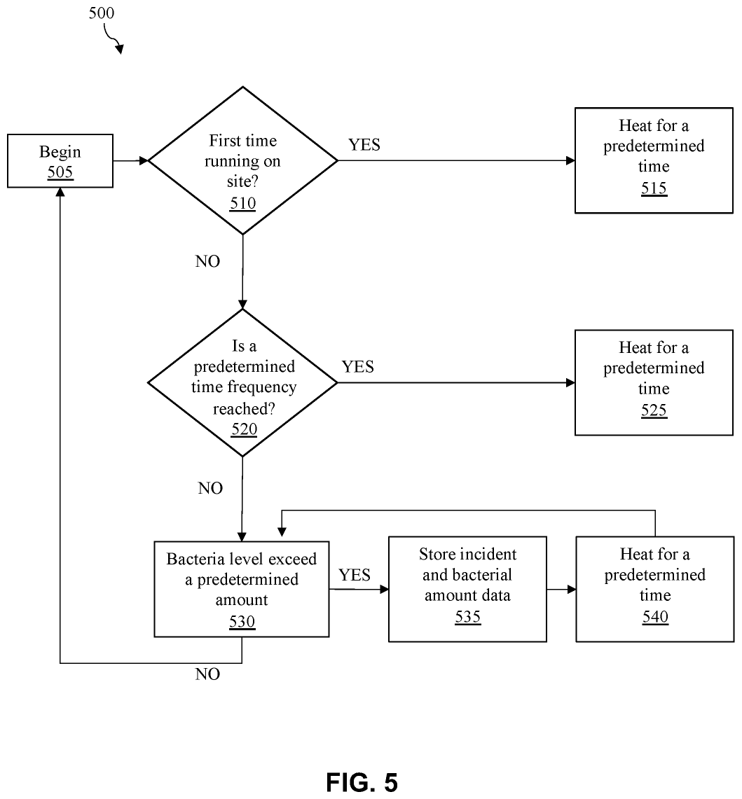

Referring now to FIG. 5, shown is an example process 500 for in-situ pasteurization of IT equipment system 400 of FIG. 4, in accordance with an embodiment of the present disclosure. The process 500 may be performed by processing logic that comprises hardware (e.g., circuitry, dedicated logic, programmable logic, microcode, etc.), software (e.g., instructions run on a processor), firmware, or a combination thereof. In some embodiments, the process 500 is a computer-implemented process. In embodiments, the process 500 may be performed by coolant conditioning unit 106 exemplified in FIG. 4.

In embodiments, the process 500 begins by activating pasteurization of system of IT equipment system 400. This is shown at step 505. The process 500 continues by determining if this is the first time the system 400 has been run at the given site. If “YES” at step 510, then the process 500 continues by heating (using heater 422) the electronics cooling liquid to the target pasteurization temperature to the predetermined pasteurization time required for bacteria neutralization. If it is not the first time running the system on site “NO” at step 510, then the process 500 continues by determining if a predetermined time frequency is reached. This is shown at step 520. For example, the system may be set to perform pasteurization based on a certain time frequency (e.g., 1 time a week, month, daily) based on historical bacteria detection data. For example, the pasteurization program may use machine learning to determine, based on analyzing historical bacteria detection data, that bacteria are typically detected after 1 week when not performing pasteurization. Therefore, the pasteurization program may automatically perform pasteurization on a weekly basis to prevent any accumulation of bacteria/biofilm within the system. If the predetermined time frequency has been reached, “YES” at step 520, the process 500 may continue to heat for a predetermined pasteurization time. This is shown at step 525.

If the predetermined time frequency has not been reached, “NO” at step 520, the process 500 continues by measuring the bacteria level with the cooling loop. This is shown at step 530. The bacteria level may be measured using detector 420 and compared to a predetermined amount/threshold/range. If the bacteria level exceeds the predetermined amount, “YES” at step 530, then the process 500 continues by storing the incident and bacterial amount data. This is shown at step 535. The stored data may be used to adjust algorithms for determining when to perform pasteurization using the system. For example, if the data indicates that bacteria is present prior to meeting the predetermined time frequency, the pasteurization program may automatically reduce when to run the system in order to neutralize bacteria growth. The process 500 continues by heating for a predetermined pasteurization time to neutralize the bacteria within the cooling loop. This is shown at step 540. If the bacteria level does not exceed the predetermined amount/threshold/range, “NO” at step 530, the process 500 returns to step 505.

Referring now to FIG. 6, shown is a high-level block diagram of an example computer system 601 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 601 may comprise one or more CPUs 602, a memory subsystem 604, a terminal interface 612, a storage interface 616, an I/O (Input/Output) device interface 614, and a network interface 618, all of which may be communicatively coupled, directly or indirectly, for inter-component communication via a memory bus 603, an I/O bus 608, and an I/O bus interface 610.

The computer system 601 may contain one or more general-purpose programmable central processing units (CPUs) 602A, 602B, 602C, and 602D, herein generically referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may include one or more levels of on-board cache. In some embodiments, a processor can include at least one or more of, a memory controller, and/or storage controller. In some embodiments, the CPU can execute the processes included herein (e.g., process 200, 300, and 500 as described in FIG. 2, FIG. 3, and FIG. 5, respectively). In some embodiments, the computer system 601 may be configured as cooling conditioning unit 106 of FIG. 1 and/or cooling conditioning unit 106 of FIG. 4.

System memory subsystem 604 may include computer system readable media in the form of volatile memory, such as random-access memory (RAM) 622 or cache memory 624. Computer system 601 may further include other removable/non-removable, volatile/non-volatile computer system data storage media. By way of example only, storage system 626 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory subsystem 604 can include flash memory, e.g., a flash memory stick drive or a flash drive. Memory devices can be connected to memory bus 603 by one or more data media interfaces. The memory subsystem 604 may include at least one program product having a set (e.g., at least one) of program modules that are configured to carry out the functions of various embodiments.

Although the memory bus 603 is shown in FIG. 6 as a single bus structure providing a direct communication path among the CPUs 602, the memory subsystem 604, and the I/O bus interface 610, the memory bus 603 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single units, the computer system 601 may, in some embodiments, contain multiple I/O bus interfaces 610, multiple I/O buses 608, or both. Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface but receives requests from other computer systems (clients). Further, in some embodiments, the computer system 601 may be implemented as a desktop computer, portable computer, laptop or notebook computer, tablet computer, pocket computer, telephone, smart phone, network switches or routers, or any other appropriate type of electronic device.

It is noted that FIG. 6 is intended to depict the representative major components of an exemplary computer system 601. In some embodiments, however, individual components may have greater or lesser complexity than as represented in FIG. 6, components other than or in addition to those shown in FIG. 6 may be present, and the number, type, and configuration of such components may vary.

One or more programs/utilities 628, each having at least one set of program modules 630 may be stored in memory subsystem 604. The programs/utilities 628 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment.

Programs/utilities 628 and/or program modules 530 generally perform the functions or methodologies of various embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pitslands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Embodiments of the present disclosure may be implemented together with virtually any type of computer, regardless of the platform is suitable for storing and/or executing program code. FIG. 7 shows, as an example, a computing environment 700 (e.g., cloud computing system) suitable for executing program code related to the methods disclosed herein and for in-situ pasteurization of an IT equipment system. In some embodiments, the computing environment 700 may be the same as or an implementation of the computing environment/IT equipment system 100 and/or 400 of FIG. 1 and FIG. 4, respectively.

Computing environment 700 contains an example of an environment for the execution of at least some of the computer code involved in performing the inventive methods, such as pasteurization program code 800. The pasteurization program code 800 may be a code-based implementation of the IT equipment system 100. In addition to pasteurization program code 800, computing environment 700 includes, for example, a computer 701, a wide area network (WAN) 702, an end user device (EUD) 703, a remote server 704, a public cloud 705, and a private cloud 706. In this embodiment, the computer 701 includes a processor set 710 (including processing circuitry 720 and a cache 721), a communication fabric 711, a volatile memory 712, a persistent storage 713 (including operating a system 722 and the pasteurization program code 800, as identified above), a peripheral device set 714 (including a user interface (UI) device set 723, storage 724, and an Internet of Things (IoT) sensor set 725), and a network module 715. The remote server 704 includes a remote database 730. The public cloud 705 includes a gateway 740, a cloud orchestration module 741, a host physical machine set 742, a virtual machine set 743, and a container set 744.

The computer 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 730. As is well understood in the art of computer technology, and depending upon the technology, performance of a computer-implemented method may be distributed among multiple computers and/or between multiple locations. On the other hand, in this presentation of the computing environment 700, detailed discussion is focused on a single computer, specifically the computer 701, to keep the presentation as simple as possible. The computer 701 may be located in a cloud, even though it is not shown in a cloud in FIG. 7. On the other hand, the computer 701 is not required to be in a cloud except to any extent as may be affirmatively indicated.

The processor set 710 includes one, or more, computer processors of any type now known or to be developed in the future. The processing circuitry 720 may be distributed over multiple packages, for example, multiple, coordinated integrated circuit chips. The processing circuitry 720 may implement multiple processor threads and/or multiple processor cores. The cache 721 is memory that is located in the processor chip package(s) and is typically used for data or code that should be available for rapid access by the threads or cores running on the processor set 710. Cache memories are typically organized into multiple levels depending upon relative proximity to the processing circuitry. Alternatively, some, or all, of the cache for the processor set may be located “off chip.” In some computing environments, the processor set 710 may be designed for working with qubits and performing quantum computing.

Computer readable program instructions are typically loaded onto the computer 701 to cause a series of operational steps to be performed by the processor set 710 of the computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as the cache 721 and the other storage media discussed below. The program instructions, and associated data, are accessed by the processor set 710 to control and direct performance of the inventive methods. In the computing environment 700, at least some of the instructions for performing the inventive methods may be stored in the pasteurization program code 800 in the persistent storage 713.

The communication fabric 711 is the signal conduction path that allows the various components of the computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

The volatile memory 712 is any type of volatile memory now known or to be developed in the future. Examples include dynamic type random access memory (RAM) or static type RAM. Typically, the volatile memory 712 is characterized by random access, but this is not required unless affirmatively indicated. In the computer 701, the volatile memory 712 is located in a single package and is internal to the computer 701, but, alternatively or additionally, the volatile memory may be distributed over multiple packages and/or located externally with respect to the computer 701.

The persistent storage 713 is any form of non-volatile storage for computers that is now known or to be developed in the future. The non-volatility of this storage means that the stored data is maintained regardless of whether power is being supplied to the computer 701 and/or directly to the persistent storage 713. The persistent storage 713 may be a read only memory (ROM), but typically at least a portion of the persistent storage allows writing of data, deletion of data and re-writing of data. Some familiar forms of persistent storage include magnetic disks and solid-state storage devices. The operating system 722 may take several forms, such as various known proprietary operating systems or open-source Portable Operating System Interface-type operating systems that employ a kernel. The code included in the pasteurization program code 800 typically includes at least some of the computer code involved in performing the inventive methods.

The peripheral device set 714 includes the set of peripheral devices of the computer 701. Data communication connections between the peripheral devices and the other components of the computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 723 may include components such as a display screen, speaker, microphone, wearable devices (such as goggles and smart watches), keyboard, mouse, printer, touchpad, game controllers, and haptic devices. The storage 724 is external storage, such as an external hard drive, or insertable storage, such as an SD card. The storage 724 may be persistent and/or volatile. In some embodiments, the storage 724 may take the form of a quantum computing storage device for storing data in the form of qubits. In embodiments where the computer 701 is required to have a large amount of storage (for example, where the computer 701 locally stores and manages a large database) then this storage may be provided by peripheral storage devices designed for storing very large amounts of data, such as a storage area network (SAN) that is shared by multiple, geographically distributed computers. The IoT sensor set 725 is made up of sensors that can be used in Internet of Things applications. For example, one sensor may be a thermometer and another sensor may be a motion detector.

The network module 715 is the collection of computer software, hardware, and firmware that allows the computer 701 to communicate with other computers through the WAN 702. The network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 715 are performed on the same physical hardware device. In other embodiments (for example, embodiments that utilize software-defined networking (SDN)), the control functions and the forwarding functions of the network module 715 are performed on physically separate devices, such that the control functions manage several different network hardware devices. Computer readable program instructions for performing the inventive methods can typically be downloaded to the computer 701 from an external computer or external storage device through a network adapter card or network interface included in the network module 715.

The WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

The end user device (EUD) 703 is any computer system that is used and controlled by an end user (for example, a customer of an enterprise that operates the computer 701) and may take any of the forms discussed above in connection with the computer 701. The EUD 703 typically receives helpful and useful data from the operations of the computer 701. For example, in a hypothetical case where the computer 701 is designed to provide a recommendation to an end user, this recommendation would typically be communicated from the network module 715 of the computer 701 through the WAN 702 to the EUD 703. In this way, the EUD 703 can display, or otherwise present, the recommendation to an end user. In some embodiments, the EUD 703 may be a client device, such as thin client, heavy client, mainframe computer, desktop computer and so on.

The remote server 704 is any computer system that serves at least some data and/or functionality to the computer 701. The remote server 704 may be controlled and used by the same entity that operates computer 701. The remote server 704 represents the machine(s) that collect and store helpful and useful data for use by other computers, such as the computer 701. For example, in a hypothetical case where the computer 701 is designed and programmed to provide a recommendation based on historical data, then this historical data may be provided to the computer 701 from the remote database 730 of the remote server 704.

The public cloud 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 705 is performed by the computer hardware and/or software of the cloud orchestration module 741. The computing resources provided by the public cloud 705 are typically implemented by virtual computing environments that run on various computers making up the computers of the host physical machine set 742, which is the universe of physical computers in and/or available to the public cloud 705. The virtual computing environments (VCEs) typically take the form of virtual machines from the virtual machine set 743 and/or containers from the container set 744. It is understood that these VCEs may be stored as images and may be transferred among and between the various physical machine hosts, either as images or after instantiation of the VCE. The cloud orchestration module 741 manages the transfer and storage of images, deploys new instantiations of VCEs and manages active instantiations of VCE deployments. The gateway 740 is the collection of computer software, hardware, and firmware that allows the public cloud 705 to communicate through the WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 706 is similar to the public cloud 705, except that the computing resources are only available for use by a single enterprise. While the private cloud 706 is depicted as being in communication with the WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 705 and the private cloud 706 are both part of a larger hybrid cloud.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed. In some embodiments, one or more of the operating system 722 and the pasteurization program code 800 may be implemented as service models. The service models may include software as a service (SaaS), platform as a service (PaaS), and infrastructure as a service (IaaS). In SaaS, the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. In PaaS, the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. In IaaS, the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used, and logical, mechanical, electrical, and other changes may be made without departing from the scope of the various embodiments. In the previous description, numerous specific details were set forth to provide a thorough understanding of the various embodiments. But the various embodiments may be practiced without these specific details. In other instances, well-known circuits, structures, and techniques have not been shown in detail in order not to obscure embodiments.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to those skilled in the art. Therefore, it is intended that the following claims be interpreted as covering all such alterations and modifications as fall within the true spirit and scope of the disclosure.

What is claimed is:

1. A computer-implemented method for in-situ pasteurization of electronics cooling liquid, the method comprising:
activating a cooling liquid pasteurization system configured to pasteurize the electronics cooling liquid of a computer system;
detecting a temperature of the electronics cooling liquid, wherein heat generated by computer electronics of the computer system is transferred to the electronics cooling liquid;
determining that the temperature of the electronics cooling liquid is within a target range that neutralizes bacteria;
maintaining the temperature of the electronics cooling liquid for a target time using the heat generated by the computer electronics of the computer system, wherein the target time corresponds to a pasteurization time frame for neutralizing bacteria in the electronics cooling liquid; and
deactivating the cooling liquid pasteurization system when the target time has been reached.

2. The method of claim 1, wherein activating the cooling liquid pasteurization system further comprises:
monitoring the electronics cooling liquid for the presence of bacteria in the electronics cooling liquid.

3. The method of claim 2, wherein monitoring the electronics cooling liquid for the presence of bacteria in the electronics cooling liquid comprises:
sending the electronics cooling liquid through a light scattering detector;
analyzing data generated by the light scattering detector to determine a presence of bacteria in the electronics cooling liquid; and
identifying, based on the analyzing, the presence of bacteria in the electronics cooling liquid.

4. The method of claim 1, further comprising:
in response to the temperature of the electronics cooling liquid being below the target range, decreasing flow rate of a heat exchanger of the computing system to a predetermined flow rate to increase the temperature of the electronics cooling liquid, wherein the heat exchanger is at least one of an air-to-liquid heat exchanger or a liquid-to-liquid heat exchanger;
monitoring the temperature of the electronics cooling liquid as the temperature increases; and
in response to the temperature of the electronics cooling liquid being within the target range, adjusting the flow rate of the heat exchanger to maintain the temperature within the target range for the target time.

5. The method of claim 1, further comprising:
in response to the temperature of the electronics cooling liquid being above the target range, increasing flow rate of a heat exchanger of the computing system to a predetermined flow rate to reduce the temperature of the electronics cooling liquid, wherein the heat exchanger is at least one of an air-to-liquid heat exchanger or a liquid-to-liquid heat exchanger;
monitoring the temperature of the electronics cooling liquid as the temperature decreases; and
in response to the temperature of the electronics cooling liquid being within the target range, adjusting the flow rate of the heat exchanger to maintain the temperature within the target range for the target time.

6. The method of claim 1, further comprising:
in response to the temperature of the electronics cooling liquid being below the target range, activating a heating source to increase the temperature of the electronics cooling liquid;
monitoring the temperature of the electronics cooling liquid as it is being heated; and
in response to the temperature of the electronics cooling liquid being within the target range, deactivating the heating source.

7. The method of claim 1, wherein the target time is determined by a machine learning model.

8. The method of claim 7, wherein determining the target time comprises:
analyzing, by the machine learning model, historical pasteurization data, wherein the historical pasteurization data comprises a plurality of pasteurization time data and a plurality of bacteria sample data;
correlating, by the machine learning model, the plurality of pasteurization time data and the plurality of bacteria sample data to determine an optimal pasteurization time frame for neutralizing bacteria in a given electronics cooling liquid; and
identifying, by the machine learning model, the target time based on the optimal pasteurization time frame.

9. The method of claim 8, further comprising:
receiving a set of new pasteurization data;
retraining the machine learning model using the set of new pasteurization data; and
adjusting, by the machine learning model and based on the retraining, the target time.

10. The method of claim 1, wherein the target range is determined by a machine learning model.

11. The method of claim 10, wherein determining the target range comprises:
analyzing, by the machine learning model, historical pasteurization data, wherein the historical pasteurization data comprises a plurality of pasteurization temperature data and a plurality of bacteria sample data;
correlating, by the machine learning model, the plurality of pasteurization temperature data and the plurality of bacteria sample data to determine an optimal temperature range for neutralizing bacteria in a given electronics cooling liquid; and
identifying, by the machine learning model, the target range based on the optimal pasteurization temperature range.

12. A system for in-situ pasteurization of electronics cooling liquid comprising:
a processor; and
a computer-readable storage medium communicatively coupled to the processor and storing program instructions which, when executed by the processor, cause the processor to perform a method comprising:
activating a cooling liquid pasteurization system configured to pasteurize the electronics cooling liquid of a computer system;
detecting a temperature of the electronics cooling liquid, wherein heat generated by computer electronics of the computer system is transferred to the electronics cooling liquid;
determining that the temperature of the electronics cooling liquid is within a target range that neutralizes bacteria;
maintaining the temperature of the electronics cooling liquid for a target time using the heat generated by the computer electronics of the computer system, wherein the target time corresponds to a pasteurization time frame for neutralizing bacteria in the electronics cooling liquid; and
deactivating the cooling liquid pasteurization system when the target time has been reached.

13. The system of claim 12, wherein activating the cooling liquid pasteurization system further comprises:
monitoring the electronics cooling liquid for the presence of bacteria in the electronics cooling liquid.

14. The system of claim 13, wherein monitoring the electronics cooling liquid for the presence of bacteria in the electronics cooling liquid comprises:
sending the electronics cooling liquid through a light scattering detector;
analyzing data generated by the light scattering detector to determine a presence of bacteria in the electronics cooling liquid; and
identifying, based on the analyzing, the presence of bacteria in the electronics cooling liquid.

15. The system of claim 12, further comprising:
in response to the temperature of the electronics cooling liquid being below the target range, decreasing flow rate of a heat exchanger of the computing system to a predetermined flow rate to increase the temperature of the electronics cooling liquid, wherein the heat exchanger is at least one of an air-to-liquid heat exchanger or a liquid-to-liquid heat exchanger;
monitoring the temperature of the electronics cooling liquid as the temperature increases; and
in response to the temperature of the electronics cooling liquid being within the target range, adjusting the flow rate of the heat exchanger to maintain the temperature within the target range for the target time.

16. The system of claim 12, further comprising:
in response to the temperature of the electronics cooling liquid being above the target range, increasing flow rate of a heat exchanger of the computing system to a predetermined flow rate to reduce the temperature of the electronics cooling liquid;
monitoring the temperature of the electronics cooling liquid as the temperature decreases; and
in response to the temperature of the electronics cooling liquid being within the target range, adjusting the flow rate of the heat exchanger to maintain the temperature within the target range for the target time.

17. A computer program product comprising a computer-readable storage medium having program instructions embodied therewith, the program instructions executable by a processor to cause the processor to perform a method for in-situ pasteurization of electronics cooling liquid, the method comprising:
activating a cooling liquid pasteurization system configured to pasteurize the electronics cooling liquid of a computer system;
detecting a temperature of the electronics cooling liquid, wherein heat generated by computer electronics of the computer system is transferred to the electronics cooling liquid;
determining that the temperature of the electronics cooling liquid is within a target range that neutralizes bacteria;
maintaining the temperature of the electronics cooling liquid for a target time using the heat generated by the computer electronics of the computer system, wherein the target time corresponds to a pasteurization time frame for neutralizing bacteria in the electronics cooling liquid; and
deactivating the cooling liquid pasteurization system when the target time has been reached.

18. The computer program product of claim 17, wherein activating the cooling liquid pasteurization system further comprises:
monitoring the electronics cooling liquid for the presence of bacteria in the electronics cooling liquid.

19. The computer program product of claim 18, wherein monitoring the electronics cooling liquid for the presence of bacteria in the electronics cooling liquid comprises:
sending the electronics cooling liquid through a light scattering detector;
analyzing data generated by the light scattering detector to determine a presence of bacteria in the electronics cooling liquid; and
identifying, based on the analyzing, the presence of bacteria in the electronics cooling liquid.

20. The computer program product of claim 17, further comprising:
in response to the temperature of the electronics cooling liquid being below the target range, decreasing flow rate of a heat exchanger of the computing system to a predetermined flow rate to increase the temperature of the electronics cooling liquid, wherein the heat exchanger is at least one of an air-to-liquid heat exchanger or a liquid-to-liquid heat exchanger;
monitoring the temperature of the electronics cooling liquid as the temperature increases; and
in response to the temperature of the electronics cooling liquid being within the target range, adjusting the flow rate of the heat exchanger to maintain the temperature within the target range for the target time.
